(19) United States
(12) Patent Application Publication
(10) Pub. No.: US 2008/0251133 A1
(43) Pub. Date: Oct. 16, 2008

(54) PUMPING VALVE WITH A SAFETY LEAKING DEVICE

(76) Inventor: Min-Hsieng Wang, Taipei City (TW)

Correspondence Address: Min-Hsieng Wang, P.O. BOX 90, Tainan City, 70499, TW

(21) Appl. No.: 11/734,780

(22) Filed: Apr. 12, 2007

(51) Int. Cl. F16K 15/20

(52) U.S. Cl. 137/231

(57) ABSTRACT

A pumping valve with a safety leaking device includes a main body and a leaking valve. The main body has an inlet tube formed vertical on its outer wall, which is bored with an air passage to communicate with the main body. The leaking valve is formed on the main body, having a valve base with male threads and a chamber bored with a through hole. A blocker base containing a blocker in its one end is inserted in the chamber. A compression spring is inserted in the chamber, too. A valve cover is covered on the valve base, having female threads formed inside it and a leaking vent bored at its outer end. When the air pumped in an object has a pressure larger than that preset, the pumping device automatically leaks air out from the leaking vent, achieving safety pumping.

### BACKGROUND OF THE INVENTION

1. Field of the Invention

This invention relates to a pumping valve with a safety leaking device, particularly to one able to automatically release the air pumped in an object from a leaking vent once the air is pumped in excess, providing a safety pumping.

2. Description of the Prior Art

Commonly, as shown in FIGS. 1 and 2, a conventional pumping valve 1 set in an air pump, a compressor or a tire pump includes a main body 10, an inlet base 11, a washer 13 and a compressing block 14. The main body 10 is provided with an accommodating chamber 100 inside it, a through hole 101 bored in its one end to communicate with the accommodating chamber 100, and two grooves 102 cut axially on its annular wall to face each other exactly. The inlet base 11 installed in the accommodating chamber 100 is provided with an inlet tube 110, which extends up vertically through one of the grooves 102 for connecting with a connecting tube 12, and an air passage 111 formed inside to communicate with the inlet base 11, and a projecting rod 112 formed to extend horizontally. The washer 13 is installed in the accommodating chamber 100, located between the inlet base 11 and the through hole 101. The compressing block 14 is installed pivotally at the inner end of the inlet base 11, provided with a compressing grip 140 formed at its end. In using, keep the through hole 101 of the main body 10 mounted on an air valve 15 to be pumped, then press down the 140 of the 14 to keep it located vertical to the inlet base 11, enabling the compressing block 14 to rotate to squeeze the washer 13, so that the inner circumference of the washer 13 is tightly attached around the outer wall of the valve 15 immovably. Then compressed by the air pump or the compressor or the tire pump, air is pumped into the inlet base 11 and the air valve 15 orderly, via the connecting tube 12.

However, such a conventional pumping valve cannot tell if air is pumped enough or not, possible to damage a machine or pose a tire blown out because of being pumped overly.

### SUMMARY OF THE INVENTION

The objective of this invention is to offer a pumping valve with a safety leaking device, which is able to automatically release the air pumped in an object from a leaking vent in case of excessively pumping the air, providing a safety pumping.

The main characteristics of the invention are a main body and a leaking valve. The main body has an inlet tube located on its outer wall, which is bored with an air passage inside it to communicate with the main body. The leaking valve is formed on the main body, provided with a valve base that has male threads formed around its outer wall and a chamber formed inside it, bored with a through hole. A blocker base containing a blocker in its one end is inserted in the chamber. A compression spring is inserted in the chamber, too. A valve cover is covered on the valve base, having female threads formed inside it and a leaking vent bored at its outer end.

### BRIEF DESCRIPTION OF DRAWINGS

This invention is better understood by referring to the accompanying drawings, wherein:

FIG. 1 is a perspective view of a conventional pumping valve;

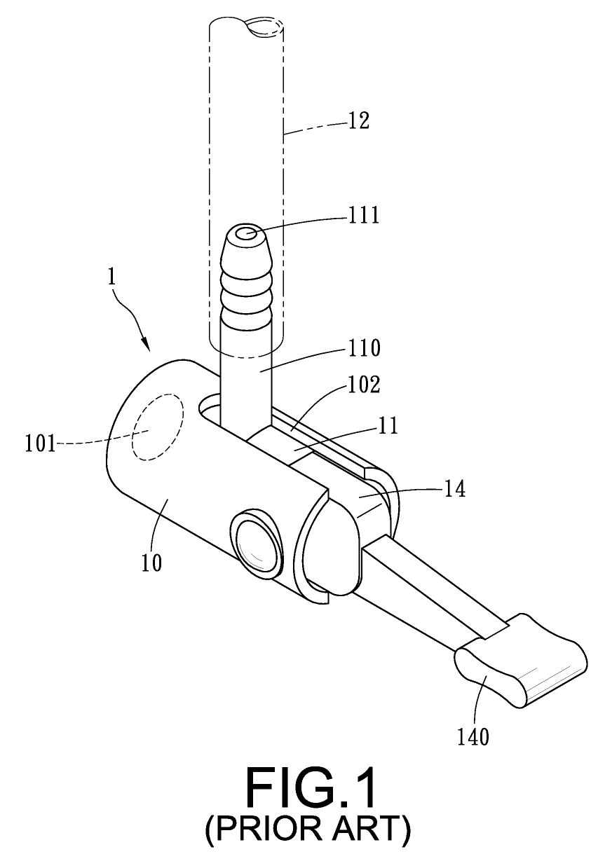

FIG. 2 is a cross-sectional view of the conventional pumping valve;

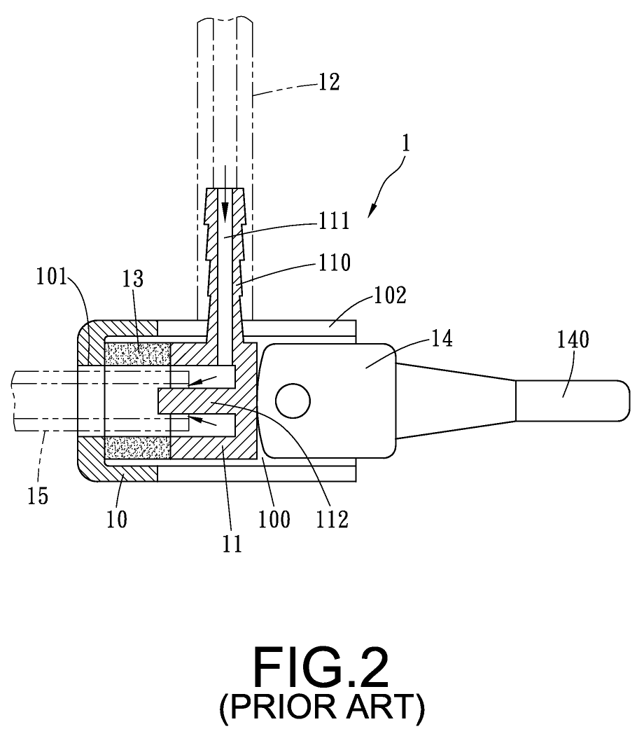

FIG. 3 is an exploded perspective view of a first preferred embodiment of a pumping valve with a safety leaking device in the present invention;

FIG. 4 is a perspective view of the first preferred embodiment of a pumping valve with a safety leaking device in the present invention;

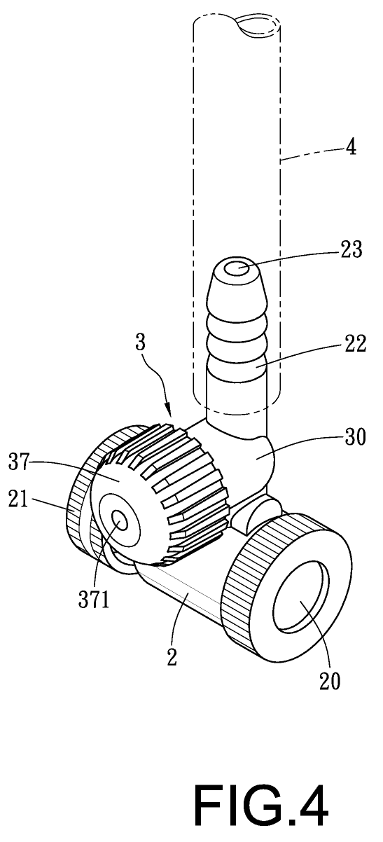

FIG. 5 is a cross-sectional view of the first preferred embodiment of a pumping valve with a safety leaking device in the present invention;

FIG. 6 is a cross-sectional view of the first preferred embodiment of a pumping valve with a safety leaking device in the present invention, showing it being over pumped with air to make its leaking valve releasing the air; and

FIG. 7 is a perspective view of a second preferred embodiment of a pumping valve with a safety leaking device in the present invention.

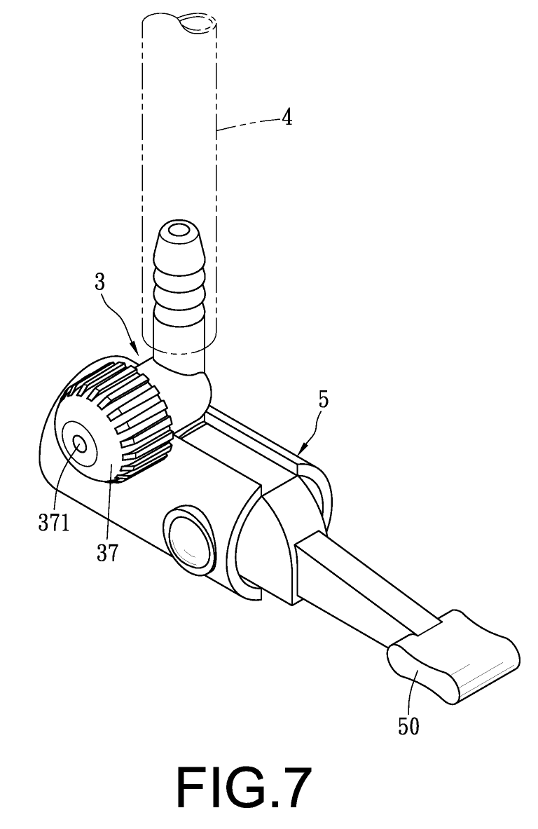

### DETAILED DESCRIPTION OF THE PREFERRED EMBODIMENT

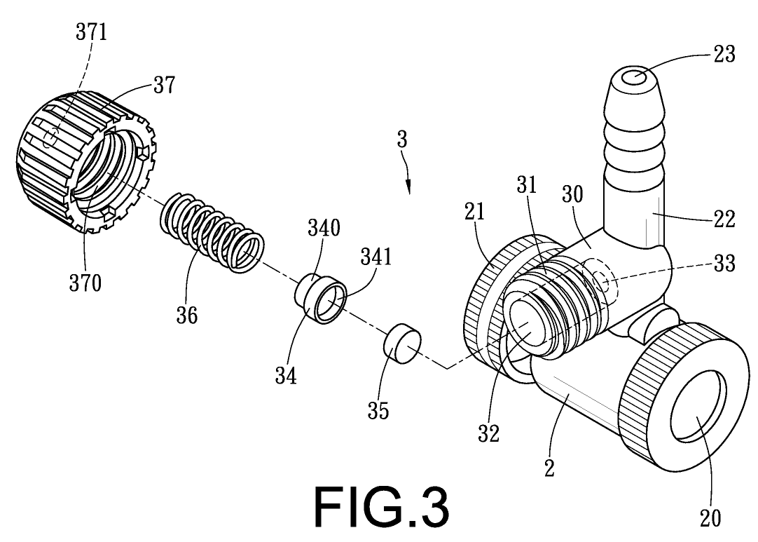

As shown in FIGS. 3˜5, a first preferred embodiment of a pumping valve with a safety leaking device in the present invention includes a main body 2 and a leaking valve 3.

The main body 2 is provided with a through hole 20 opened in its one end, a knob 21 located at the other end, an inlet tube 22 extended vertically on its outer wall, and an air passage 23 bored inside the inlet tube 22 to communicate with its interior.

The leaking valve 3 is installed on the main body 2, provided with a valve base 30 set vertically on the outer wall of the inlet tube 22, having male threads 31 formed around its outer wall, a chamber 32 formed in its interior. A through hole 33 is bored at the end of the chamber 32 for communicating with the air passage 23 of the inlet tube 22. The leaking valve 3 is also provided with a blocker base 34, which is inserted in the chamber 32, having an annular projection 340 extended at its one end and a center recess 341 concaved in the annular projection 340 for accommodating a blocker 35 therein. In addition, a compression spring 36 is also installed in the chamber 32, with one end fitted around the projection 340. And, a valve cover 37 is threadably covered on the valve base 30, provided with female threads 370 formed inside it and a leaking vent 371 bored at its outer end.

In assembly, as shown in FIGS. 3˜5, the blocker 35 is first inserted in the recess 341 of the blocker base 34 and then, the compression spring 36 is fitted around the projection 340 with its one end. Next, the compression spring 36, the blocker base 34 and the blocker 35 combined together are inserted in the chamber 32 of the valve base 30. The valve cover 37 is successively covered on the valve base 30, with the female threads 370 engaged with the male threads 31 to keep the other end of the compression spring 36 leaning elastically against the inner wall of the valve cover 37. By the time, the blocker 35 is pushed elastically by the compression spring 36 to attach on the inward end of the chamber 32, keeping the through hole 33 sealed. Thus, the whole assembly is done.

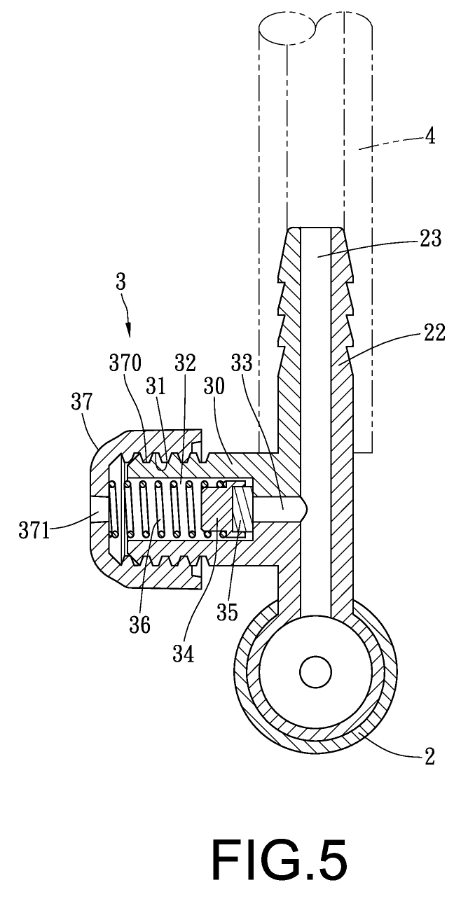

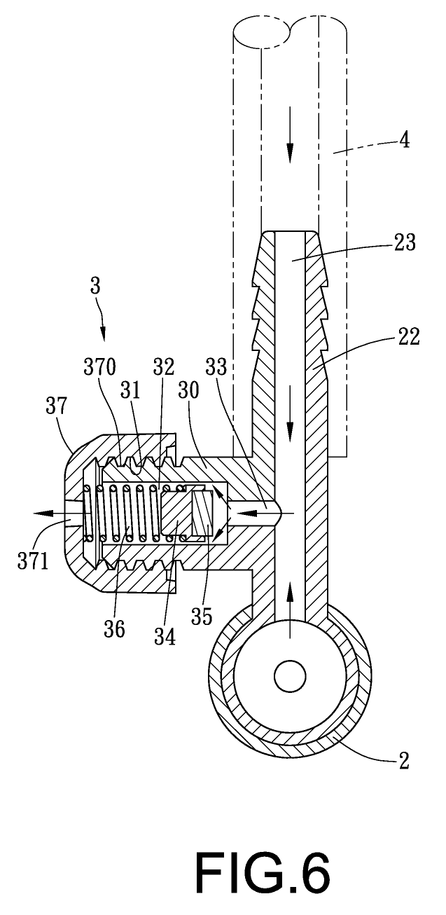

In using, a user can first turn around the valve cover 37 to adjust the compression force afforded by the compression spring 36, for deciding the pressure of the air to be obtained. Then, as shown in FIGS. 5 and 6, keep the through hole 20 of the main body 2 connected with the air valve of an object, such as a tire or a ball etc., to be pumped, without being illustrated in drawings. When an air pump or a compressor or a tire pump, etc. is initiated to work, air is to be blown into the main body 2 through a connecting tube 4 and then into an object to be pumped. If the pressure inside the object reaches to that preset, the blocker 35 is to be pushed away the inner end of the chamber 32 so as to squeeze the compression spring 36, keeping the blocker 35 moved away the through hole 33 in the valve base 30 to let the air flow out through the chamber 32 and the leaking vent 371 of the valve cover 37 orderly. When the pressure inside the object is dropped, the compression spring 36 is to elastically push the blocker 35 back to its original position to seal up the through hole 33 again. That is, when the air is overly pumped, it can automatically leak out from the leaking vent 371 of the valve cover 37 to prevent the object, such as a machine or a tire, from damaged or blown out, achieving a safety effect.

A second preferred embodiment of a safety leaking device for a pumping valve in the present invention, shown in FIG. 71 has the same components as the first one does, except that it additionally includes a compressing grip 50 provided in its pumping valve 5.

While the preferred embodiment of the invention has been described above, it will be recognized and understood that various modifications may be made therein and the appended claims are intended to cover all such modifications that may fall within the spirit and scope of the invention.

What is claimed is:

1. A pumping valve with a safety leaking device comprising:
a main body provided with an inlet tube located vertically on its outer wall, an air passage formed inside said inlet tube to communicate with its interior; and
a leaking valve formed on said main body and provided with a valve base that has male threads formed around its outer wall and a chamber formed inside it, a through hole 33 bored at an end of said chamber, said leaking valve additionally provided with a blocker base that is inserted in said chamber and accommodate a blocker in its one end, a compression spring put in said chamber of said valve base, and a valve cover threadably covered on said valve base with female threads formed inside it and a leaking vent bored at its outer end.

2. The pumping valve with a safety leaking device as claimed in claim 1, wherein said valve base is provided with an annular projection formed at its one end and a center recess concaved in said annular projection.
